(19) United States
(12) Patent Application Publication
(10) Pub. No.: US 2013/0083241 A1
(43) Pub. Date: Apr. 4, 2013

(54) VIDEO DISPLAY APPARATUS AND DISPLAY CONTROL METHOD

(71) Applicant: Junko Sakurai, Musashino-shi (JP)

(72) Inventor: Junko Sakurai, Musashino-shi (JP)

(73) Assignee: KABUSHIKI KAISHA TOSHIBA, Tokyo (JP)

(21) Appl. No.: 13/569,495

(22) Filed: Aug. 8, 2012

(30) Foreign Application Priority Data
Sep. 30, 2011 (JP) 2011-218691

(51) Int. Cl. H04N 7/00; H04N 5/44

(52) U.S. Cl. 348/553; 348/739; 348/E05.096; 348/E07.001

(57) ABSTRACT

A video display apparatus includes: a display module that displays a video; an illuminating module that illuminates the display module; a battery that supplies a power to the display module and the illuminating module; and a display controller that controls the illuminating module to continue illuminating and the display module to switch display of video when the video display apparatus is driven by the battery.

### CROSS REFERENCE TO RELATED APPLICATION(S)

The present disclosure relates to the subject matter contained in Japanese Patent Application No. 2011-218691 filed on Sep. 30, 2011, which is incorporated herein by reference in its entirety.

### FIELD

One or more embodiments of the present invention relate to a video display apparatus and a display control method.

### BACKGROUND

Recently, power saving countermeasures for power supplied from an electric power generating plant of an electric supply company comes to an issue. If overall power consumption in a district is increased with respect to the amount of electric power distribution from the electric power generating plant, a power failure may occur, and as a result, plants, hospitals, and so forth may be considerably damaged.

As a measure of the power failure problem, there is disclosed an information terminal in which the capacity of backup power that is used at the time of power failure is reduced by lowering the brightness of a backlight that illuminates a display module when the interior brightness is dark.

A television receiver (TV) is introduced equipped with a countermeasure for the power failure. For example, a built-in battery is provided in the TV so that a user can watch the broadcasting programs even when an external power is not supplied to the TV.

When the power failure occurs, interior lightings are turned OFF and the interior becomes dark causing problems with daily activities. Therefore, there is a need to use a device capable of being driven by a battery for lightings.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIGS. 1A and 1B are views illustrating operations in respective operation modes of a TV according to an exemplary embodiment.

FIG. 2 is a block diagram illustrating a representative example of an overall configuration of the TV according to the exemplary embodiment.

FIG. 3 is a block diagram illustrating operations in respective operation modes of the TV according to the exemplary embodiment.

FIG. 4 is an exemplary screen for selecting an operation mode of the TV according to the exemplary embodiment.

FIG. 5 is a flow chart illustrating a procedure that switches the operation mode of the TV according to the exemplary embodiment.

### DETAILED DESCRIPTION OF THE EMBODIMENTS

According to one embodiment, there is provided a video display apparatus including: a display module that displays a video; an illuminating module that illuminates the display module; a battery that supplies a power to the display module and the illuminating module; and a display controller that controls the illuminating module to continue illuminating and the display module to switch display of video when the video display apparatus is driven by the battery.

Hereinafter, one or more embodiments will be described with reference to the accompanying drawings.

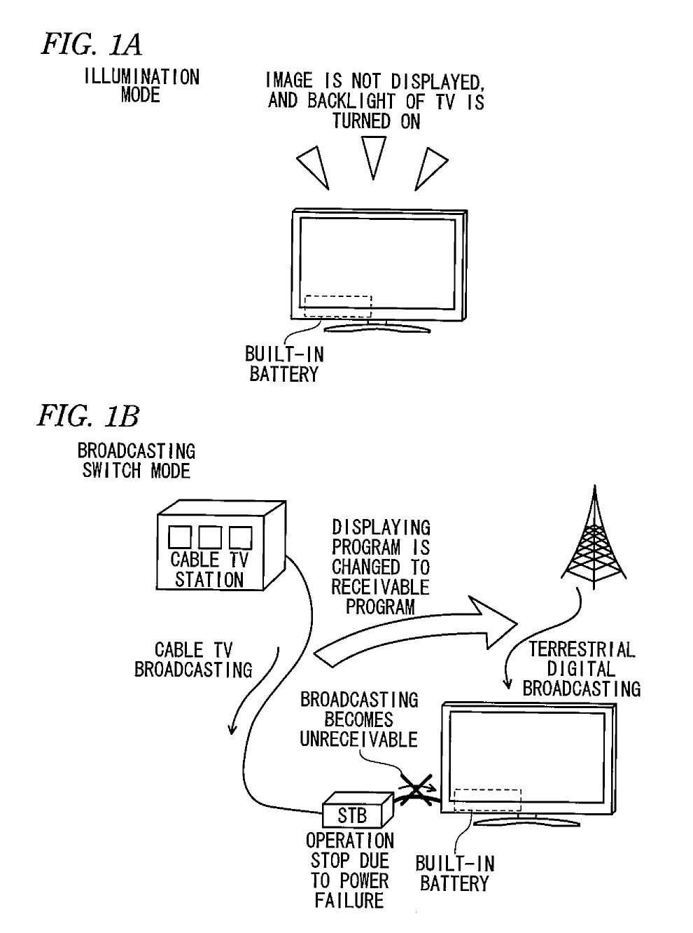

FIGS. 1A and 1B are views illustrating operations of a TV 100 in each operation mode according to an exemplary operation mode when the TV 100 is driven by a built-in battery. That is, when the commercial power is not supplied due to a power failure, the TV 100 is operated using the built-in battery as a power supply source. FIG. 1A shows an operation when an illumination mode is selected and FIG. 1B shows an operation when a broadcasting switch mode is selected.

First, in the illumination mode of FIG. 1A, the broadcasting signal that is input through an antenna or a cable is not processed, but the backlight is continuously turned on so that the TV 100 is used as lighting.

Next, in the broadcasting switch mode of FIG. 1B, the broadcasting signal that is being selected but cannot be received due to the power failure is switched into another receivable broadcasting signal. For example, when the operation of a set-top box that is provided between a cable TV station and the TV 100 becomes inoperative due to the power failure and the selected cable TV broadcasting becomes unreceivable, the broadcasting is automatically switched into a receivable terrestrial digital broadcasting.

As described above, the TV 100 according to the present embodiment includes an illumination mode as shown in FIG. 1A and a broadcasting switch mode as shown in FIG. 1B, and can be used even during the power failure. Hereinafter, the configuration and the operation of the TV 100 according to the present embodiment will be described.

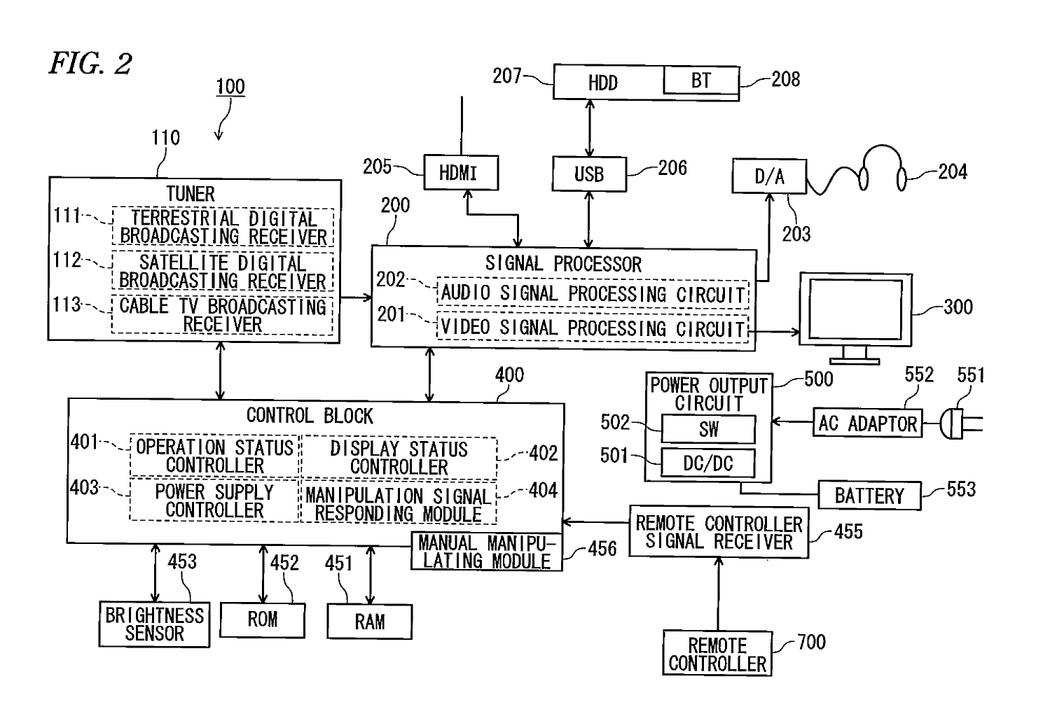

FIG. 2 is a block diagram showing a representative example of an overall configuration of the TV 100 according to the present embodiment.

Herein, a tuner 110 receives broadcasting signals corresponding to three broadcasting modes including terrestrial digital broadcasting, satellite digital broadcasting, and cable TV broadcasting through an antenna and a cable which are not shown. That is, the tuner 110 includes a terrestrial digital broadcasting receiver 111, a satellite digital broadcasting receiver 112, and a cable TV broadcasting receiver 113. Herein, the cable TV broadcasting refers to a broadcasting that is provided by a service provider (hereinafter, referred to as a conditional access system (CAS)) such as a distributing provider that distributes programs by a wired method (cable TV company).

The broadcasting signal that is receivable at the tuner 110 is not limited to the above-mentioned three signals, but other types of broadcasting signal may be received. For example, the tuner 110 may also receive contents distributed via the Internet.

The tuner 110 selects a broadcasting signal out of the three broadcastings, demodulates the broadcasting signal of a selected channel, and obtains a transport stream including a desired program to input the transport stream to a signal processor 200.

The demodulated program signal included in the channel selected by the tuner 110 is input to the signal processor 200 which includes a video signal processing circuit 201 and an audio signal processing circuit 202. The video signal processing circuit 201 decodes (decrypts) an encoded video signal into a video signal of an original baseband. The encoding/decoding method may include, for example, a Moving Picture Experts Group (MPEG), H.264/Advanced Video Coding (AVC) or the like. The video signal of the baseband that is output from the video signal processing circuit 201 is provided to a display device 300.

The audio signal processing circuit 202 extracts an audio stream out of the program signal and then decodes the extracted audio stream. The decoded audio signal is converted into an analog signal by a digital to analog converter 203, and is supplied to a speaker 204. In the example of the drawing, even though a headphone is shown, the speaker is not limited thereto, but may be a standing type speaker.

The signal processor 200 may be connected to an external equipment under the control of a control block 400. For example, the signal processor 200 may be connected to an external information recording and reproducing apparatus, such as for example, an optical disc (DVD, BD (registered trademark), or the like) recording and reproducing apparatus through a high definition multimedia interface (HDMI) 205. Therefore, the signal processor 200 receives a reproduced signal from the external information recording and reproducing apparatus to perform a signal processing for a display output and an audio output. The signal processor 200 may transmit a recording signal to the external information recording and reproducing apparatus.

The signal processor 200 may also be connected to a hard disc drive (HDD) 207 through a universal serial bus (USB) 206 under the control of the control block 400. The hard disc drive 207 has a battery 208 and can be self-driven, for example, for about two or three hours at the time of power failure. The hard disc drive may supply a power to other block based on the control signal.

The control block 400 includes an operating status controller 401, a display status controller 402, a power supply controller 403, and a manipulation signal responding module 404.

The operating status controller 401 controls the status of a block in the TV 100 in response to an external or internal status signal or a manipulation signal from the outside. For example, the broadcasting received by the tuner 110 is switched between terrestrial digital broadcasting, satellite digital broadcasting, or cable TV broadcasting. The signal processing status in the signal processor 200 may be controlled. For example, regardless of an automatic mode or a manual mode, color adjustment, brightness adjustment, partial shut off of a power supply may be controlled in accordance with a set condition.

The display status controller 402 adjusts the backlight of the display device 300 and controls the illumination area of the backlight. The display status controller 402 further controls the brightness of the video signal and the enlargement or reduction, and controls the movement of the displaying position.

The power supply controller 403 controls a power supply output circuit 500, and switches the usage status of a power supply of the TV 100 to a usage status of a commercial power supply (external power supply) or a usage status of a battery power. The switch 502 is controlled by the power supply controller 403, so that the usage status of a power supply is switched.

The manipulation signal responding module 404 analyzes a manipulation signal when the manipulation signal transmitted from a remote controller 700 is input through a remote controller signal receiver 455. The manipulation signal responding module 404 controls the operation status of the TV 100 based on the analyzed result of the manipulation signal. As the operation status, a main power supply is turned ON or OFF. The manipulation signal may be input not only from the remote controller receiver 455, but also from a manual manipulating module 456. If the manual manipulating module 456 is operated by the user, the manipulation signal is analyzed by the manipulation signal responding module 404.

A random access memory (RAM) 451 is so-called a working memory in which various programs are expanded. The memory can be any type of a RAM as long as the memory is recordable or readable. For example, the RAM may be a nonvolatile memory. Various data (icon, warning textual information, channel number, etc.) for on screen display (OSD) may well be stored on the RAM 451. In the present embodiment, data for displaying an operation mode selection screen 302 which will be described below is also stored.

A read only memory (ROM) 452 is connected to the control block 400, and for example, various software that is used in the TV are stored in the ROM 452. When the TV 100 is operated, the software is expanded in, for example, the RAM 451 to perform the operational procedure according to the manipulation signal or a command signal.

A brightness sensor 453 is connected to the control block 400, and may obtain information regarding the brightness of the outside of a case of the TV 100.

Next, descriptions will be given for a power supply system. A commercial AC power that is input from a plug 551 is rectified in an AC adaptor 552 to be input to a power output circuit 500, which, in turn, converts the AC power into various DC voltages using the output from the adaptor 552. When the AC adaptor is not provided, the power output circuit 500 rectifies the commercial AC power to generate DC voltages having various values. The power output circuit 500 receives the DC power from the battery 553 and switches the DC voltage in a DC/DC converter 501 to generate DC voltages having various values.

The power output circuit 500 switches the power usage status of the TV 100 between the usage status of the commercial power supply (external power supply) and the usage status of the battery power under the control of the power supply controller 403.

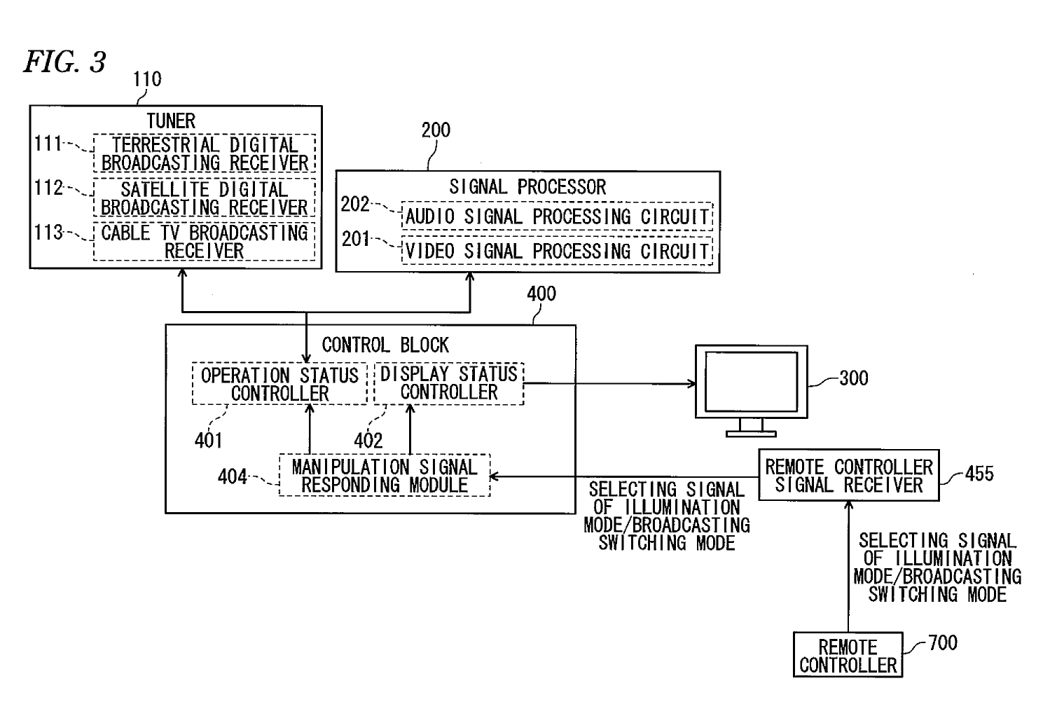

FIG. 3 is a block diagram illustrating operations in each operation mode of the TV 100 according to the present embodiment.

First, the remote controller 700 transmits a signal that selects an illumination mode or a broadcasting switching mode in response to the manipulation of a user to the remote controller signal receiver 455. The remote controller signal receiver 455 inputs the received illumination mode or broadcasting switching mode selection signal to the manipulation signal responding module 404.

The manipulation signal responding module 404 controls the video signal processing circuit 201 of the signal processor 200 based on the illumination mode selection signal and stops the processing of the video signal. The manipulation signal responding module 404 controls the tuner 110 based on the broadcasting switching mode selection signal and converts the broadcasting signal to be output to the signal processor 200.

The display status controller 402 controls the brightness of the backlight (LED) of the display device 300 or reduces the illumination area of the backlight in response to the brightness outside the TV 100. According to the present embodiment, the display status controller 402 controls the brightness of the backlight based on the external brightness information input from the brightness sensor 453. Therefore, when the illumination mode is selected, the TV 100 is used as an illumination device that provides a required amount of light according to the external brightness.

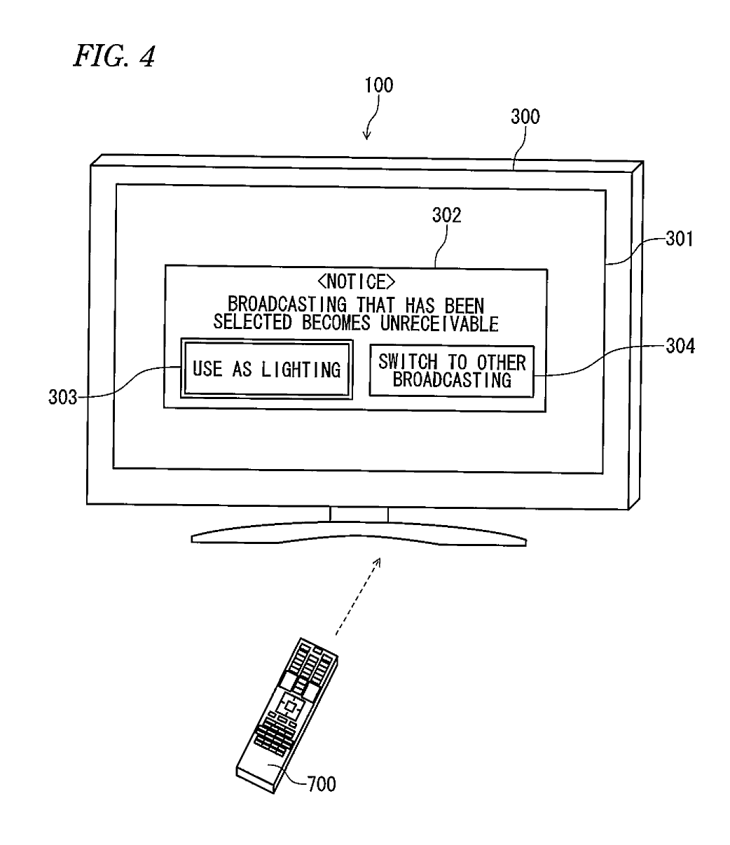

FIG. 4 is an example of a screen for selecting an operation mode of the TV 100 according to the present embodiment. The display device 300 is configured by a display module 301 and a backlight (illuminating module) that illuminates the display module 301 from the inside of the case of the display device 300 toward the outside. The operation mode selection screen 302 is displayed on the display module 301.

As an example of the configuration of the backlight, there is provided a backlight including a light guiding plate, a horizontal light source that is arranged so as to face a thickness side perpendicular to the light guiding plate, and a vertical light source that is arranged so as to face a thickness side in a horizontal direction of the light guiding plate. The light emitted from the respective light sources is reflected inside of the light guiding plate and then output in the front direction of the light guiding plate. As elements for the light sources, for example, a plurality of light emitting diodes (LED) are used. The emitted light from the respective light sources is diffused in the light guiding plate so as to be output as uniform light toward the front side. As another configuration of the backlight, a substrate on which the light emitting diodes (LED) are two-dimensionally arranged may be disposed on a rear side of a glass substrate of the display device 300.

On the operation mode selection screen 302, an illumination mode selection button 303 and a broadcasting switch mode selection button 304 are selectively displayed to be selected. The user can manipulate the remote controller 700 to select the illumination mode selection button 303 and the broadcasting switch mode selection button 304.

If the illumination mode selection button 303 is selected, the operation status controller 401 controls the tuner 110 based on the manipulation signal from the manipulation signal responding module 404 and stops receiving the broadcasting signal. By doing this, the operations of the tuner 110, the signal processor 200, the digital to analog converter 203, and the speaker 204 and the video display operation in the display device 300 are stopped so that the power saving can be achieved.

Alternatively, if the illumination mode selection button 303 is selected, the tuner 110 continuously receives signals, and the tuner 110 may not output the broadcasting signal to the signal processor 200. In this case, the operations of the signal processor 200, the digital to analog converter 203, and the speaker 204 and the video display operation in the display device 300 are stopped so that the power saving can be achieved.

If the illumination mode selection button 303 is selected, the tuner 110 continuously receives signals, the signal processor 200 continuously processes the signals, and the broadcasting signal may not be output to the digital to analog converter 203 or the display device 300. In this case, the operations of the speaker 204 and the video display operation in the display device 300 are stopped so that the power saving can be achieved.

If the broadcasting switch mode selection button 304 is selected, the operation status controller 401 controls the tuner 110 based on the manipulation signal from the manipulation signal responding module 404 and controls to select another receivable broadcasting signal to be output to the signal processor 200. If the broadcasting signal which is being selected is not receivable, the broadcasting switch mode selection button 304 is not displayed or displayed as a non-selectable status.

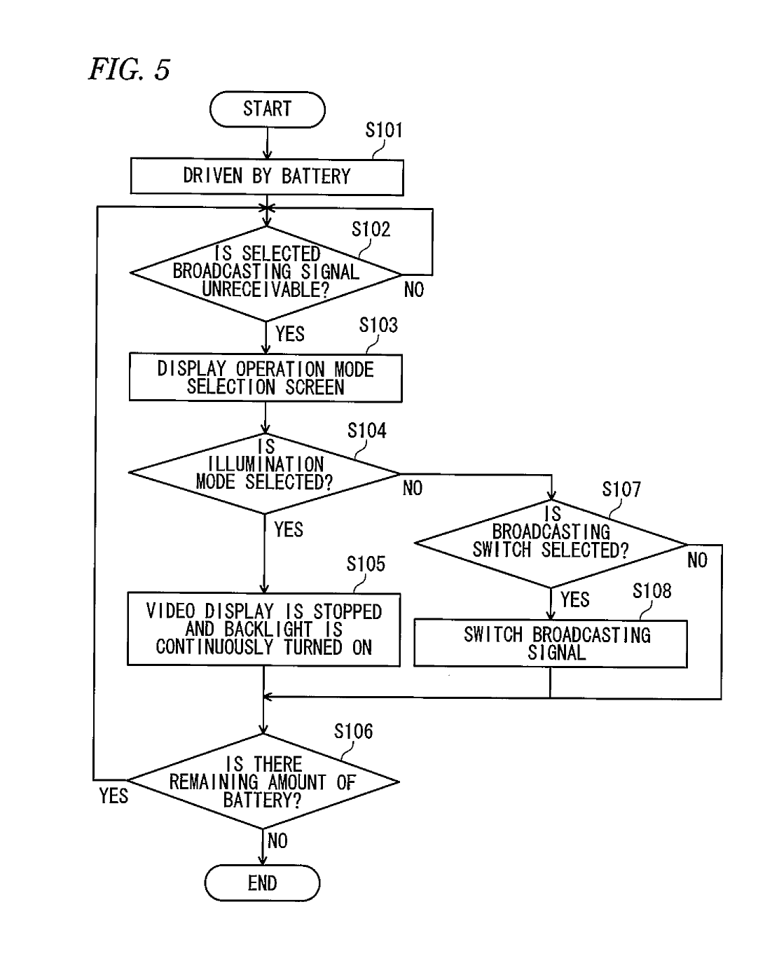

FIG. 5 is a flow chart illustrating a procedure that switches the operation mode of the TV 100 according to the present embodiment.

First, the power supply controller 403 controls the power supply output circuit 500 to use a battery 553 as the power supply source of the TV 100 (step S101). In other words, the TV 100 is in a battery driven status.

Next, the operation status controller 401 determines whether the broadcasting signal which is being selected is unreceivable (step S102). As the determination result at step S102, if it is determined that the broadcasting signal being selected is receivable (“No” at step S102), the sequence proceeds to step S102. In the meantime, as the determination result at step S102, if it is determined that the broadcasting signal being selected is unreceivable (“Yes” at step S102), the operation status controller 401 displays the operation mode selection screen 302 based on the data stored in the RAM 451 (step S103).

Next, the manipulation signal responding module 404 determines whether the illumination mode selection button 303 is selected (step S104). As the determination result at step S104, if it is determined that the illumination mode selection button 303 is selected (“Yes” at step S104), the operation status controller 401 controls the signal processor 200 to stop displaying the video and continuously turns ON the backlight (step S105).

Next, the power supply controller 403 determines whether there is a remaining amount of the battery 553 (step S106). As the determination result at step S106, if it is determined that there is a remaining amount of the battery 553 (“Yes” at step S106), the sequence proceeds to step S102. In the meantime, as the determination result at step S106, if it is determined that there is no remaining amount of the battery 553 (“No” at step S106), the operation mode selection procedure is ended. That is, if there is no remaining amount of the battery 553, the operation of the TV 100 becomes impossible.

In the meantime, as the determination result at step S104, if it is determined that the illumination mode selection button 303 is not selected (“No” at step S104), the manipulation signal responding module 404 determines whether the broadcasting switch mode selection button 304 is selected (step S107). As the determination result at step S107, if it is determined that the broadcasting switch mode selection button 304 is selected (“Yes” at step S107), the signal is switched to a receivable broadcasting signal (step S108). In the meantime, as the determination result at step S107, if it is determined that the broadcasting switch mode selection button 304 is not selected (“No” at step S107), the sequence proceeds to step S106. Therefore, the operation mode selection procedure is ended.

In the above description, when the broadcasting signal which is being selected at step S102 cannot be received, the operation mode selection screen 302 is output to select the illumination mode and the broadcasting switch mode. However, the present invention is not limited thereto. For example, the remote controller 700 is manipulated to output the operation mode selection screen 302 or directly select each of the operation modes. If the TV 100 is changed to a battery driven mode, the mode may be automatically switched to the illumination mode.

According to the TV 100 with the above configuration, during being driven with the battery, the TV 100 may be used as lighting. That is, if the illumination mode is selected during being driven with the battery, displaying a video on the display module 301 is stopped and only the backlight is continuously turned ON. Therefore, the power saving in the respective modules for video processing is achieved and the TV 100 may be used as lighting for illuminating the interior space even at the time of power failure.

If the selected broadcasting signal cannot be received at the time of power failure, the broadcasting is automatically switched and thereby the convenience of the TV device is improved. With the above-mentioned operation mode, the TV 100 can be expanded in application at the time of power failure.

Although the embodiments of the present invention have been described, the embodiments are only illustrative purposes, and are not intended to limit the scope of the invention. It is further possible to utilize various embodiments of the present invention, as well as various alternatives and modifications thereof. Various omissions, changes, or modifications can be made without departing the scope of the present invention. All such changes, modifications, variations and other uses and applications which do not depart from the spirit and scope of the invention are deemed to be covered by the invention which is limited only by the claims and the equivalents thereof.

What is claimed is:

1. A video display apparatus comprising:
a display configured to display a video;
an illuminator configured to illuminate the display;
a battery configured to supply a power to the display and the illuminator; and
a display controller configured to control the illuminator to continue illuminating and the display to switch display of video when power is supplied by the battery.

2. The video display apparatus of claim 1, wherein the display is configured not to display the video when power is supplied by the battery.

3. The video display apparatus of claim 1 further comprising
a content receiver configured to receive content corresponding to video to be displayed by the display, the content comprising first content and second content,
wherein when the first content becomes unreceivable, the display controller is configured to switch the video to video based on second content that is receivable at the receiver.

4. The video display apparatus of claim 1 further comprising
a broadcast receiver configured to receive broadcasting signals, the broadcasting signals comprising a first broadcast signal and a second broadcast signal,
wherein the display controller is configured to
display a first video based on the first broadcasting signal, and
switch the first video to a second video based on the second broadcasting signal that is receivable at the receiver when the first broadcasting signal becomes unreceivable while the first video is displayed by the display.

5. A display control method comprising:
displaying a video on a display;
illuminating the display with an illuminator;
supplying power to the display and the illuminator from a battery; and
controlling the illuminator to continue illuminating and controlling the display to switch display of the video when power is supplied from the battery.
